(19) United States
(12) Patent Application Publication
(10) Pub. No.: US 2016/0097665 A1
(43) Pub. Date: Apr. 7, 2016

(54) DYNAMIC, DISTRIBUTED-SENSOR, FLUID-MONITORING SYSTEM

(71) Applicant: Water Meter Solutions, LLC, Minneapolis, MN (US)

(72) Inventors: Josh Becerra, Saint Paul, MN (US); Colin Hirdman, Minneapolis, MN (US); Zack Steven, Edina, MN (US); Andrew Aarestad, Minneapolis, MN (US)

(21) Appl. No.: 14/876,173

(22) Filed: Oct. 6, 2015

Related U.S. Application Data
(60) Provisional application No. 62/140,971, filed on Mar. 31, 2015.
(60) Provisional application No. 62/060,366, filed on Oct. 6, 2014.

(51) Int. Cl. G01F 3/00; E03B 7/07

(52) U.S. Cl. CPC G01F 3/00; E03B 7/072

(57) ABSTRACT

A system used to detect and communicate information regarding leaks in water systems at a source. The system includes a power source, a processor, a flow sensor, a radio, and an energy-harvesting turbine. The flow sensor detects and measures fluid flow coming from the water supply line into the tank or other device traditionally connected to pipes. The radio then communicates and relays the measured fluid flow information to a wireless router or gateway using any variety of custom or standard wireless protocols.

### CROSS-REFERENCE TO RELATED APPLICATIONS

This application claims the benefit of U.S. Provisional Patent Application No. 62/140,971, filed on Mar. 31, 2015, titled DYNAMIC, DISTRIBUTED-SENSOR, FLUID-MONITORING SYSTEM, and claims the benefit of U.S. Provisional Patent Application No. 62/060,366, filed on Oct. 6, 2014, titled DYNAMIC, DISTRIBUTED-SENSOR, FLUID-MONITORING SYSTEM.

### FIELD OF THE DISCLOSURE

A detection system for monitoring water flow through water systems. More specifically, a system having a device and corresponding software, wherein the device collects water flow data for the corresponding software to analyze and is comprised of a power source, a processor, a flow sensor, a radio, and an energy-harvesting turbine.

### BACKGROUND OF THE INVENTION

Currently, multi-family housing owners have no way of monitoring water leakage within their buildings. Excessively high water bills can often be attributed to waste from running toilets or other water outlets (sinks, washing machines etc . . . ). For example, one undetected running toilet is capable of causing $300 per month of water waste. Water bills can, therefore, be thousands of dollars more than necessary for property owners, and the majority of this is due to undetected running toilets. Additionally, tenants in multi-family housing usually do not pay for water usage and, therefore, do not have an incentive to report leaky and running toilets and other water outlets. Quickly identifying and fixing water leakage sources saves money, protects property, and conserves water. Therefore, a system for owners to monitor water flow through water systems, such as toilets, is needed.

### SUMMARY OF THE INVENTION

The system disclosed herein is used to detect leaks in water systems at a source such as, but not limited to, a toilet, shower, bathtub, sink, dishwasher, garden hose, hot water heater, or HVAC system. The system, in one embodiment, includes a power source such as a battery, a rechargeable battery, or a capacitor, and further includes a processor, a flow sensor, a radio, and an energy-harvesting turbine.

### BRIEF DESCRIPTION OF THE DRAWINGS

FIG. 1 illustrates one embodiment of the device of the disclosed system.

FIG. 2 illustrates one embodiment of the disclosed system connected to a toilet.

FIG. 3 illustrates one embodiment of the disclosed system connected to a toilet.

FIG. 4 illustrates one embodiment of the disclosed system connected to a toilet.

FIG. 5 illustrates one embodiment of the disclosed system as set up for a multi-unit building.

FIG. 6 illustrates one embodiment of the disclosed system connected to a faucet.

FIG. 7 illustrates one embodiment of the disclosed system connected to a dishwasher.

FIG. 8 illustrates one embodiment of the disclosed system connected to a washing machine.

FIG. 9 illustrates embodiments of the disclosed device having various plumbing fittings.

FIG. 10 is an example graphical user interface showing a mobile interface login screen according to one embodiment of the present invention.

FIG. 11 is an example graphical user interface showing a mobile interface dashboard monitor screen according to one embodiment of the present invention.

FIG. 12 is an example graphical user interface showing a mobile interface individual unit screen according to one embodiment of the present invention.

FIG. 13 illustrates one embodiment of the software architecture.

FIG. 14 illustrates one embodiment of the disclosed system.

FIG. 15 is a schematic block diagram depicting an example computing system used in accordance with one embodiment of the present invention.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover application or embodiments without departing from the spirit or scope of the claims attached hereto. Also, it is to be understood that the phraseology and terminology used herein are for the purpose of description and should not be regarded as limiting.

Flow meters typically measure bulk fluid movement. One example of such a device is a turbine flow meter, which is built to measure the mechanical action of the turbine when it is rotated around an axis by the flow of liquid and to translate that measurement into a user-readable rate of flow. Conventional turbine flow meters have a wheel that is set in the path of a fluid stream so that, when the fluid flows, it pushes the turbine blades and sets a rotor in motion. Because the speed of the wheel rotation is proportional to the velocity of the fluid, once a steady rotation speed is reached for the wheel, the turbine can output a rate of flow for the user.

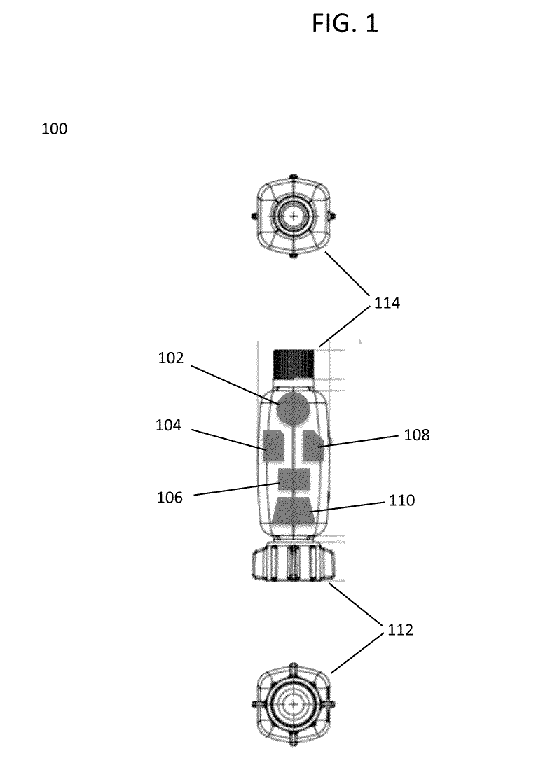

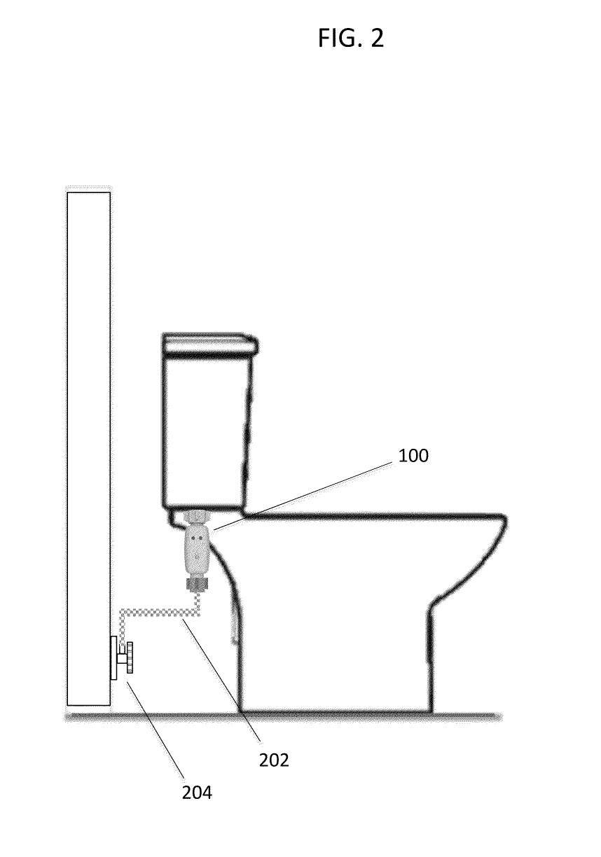

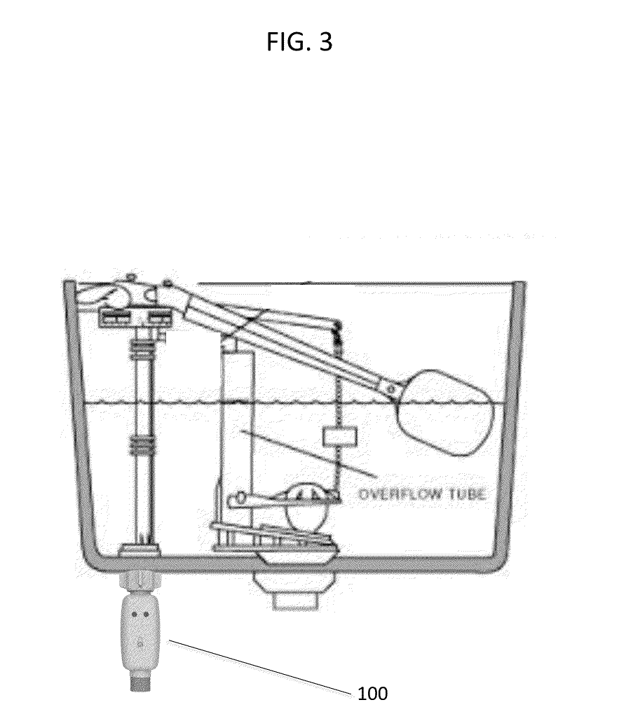

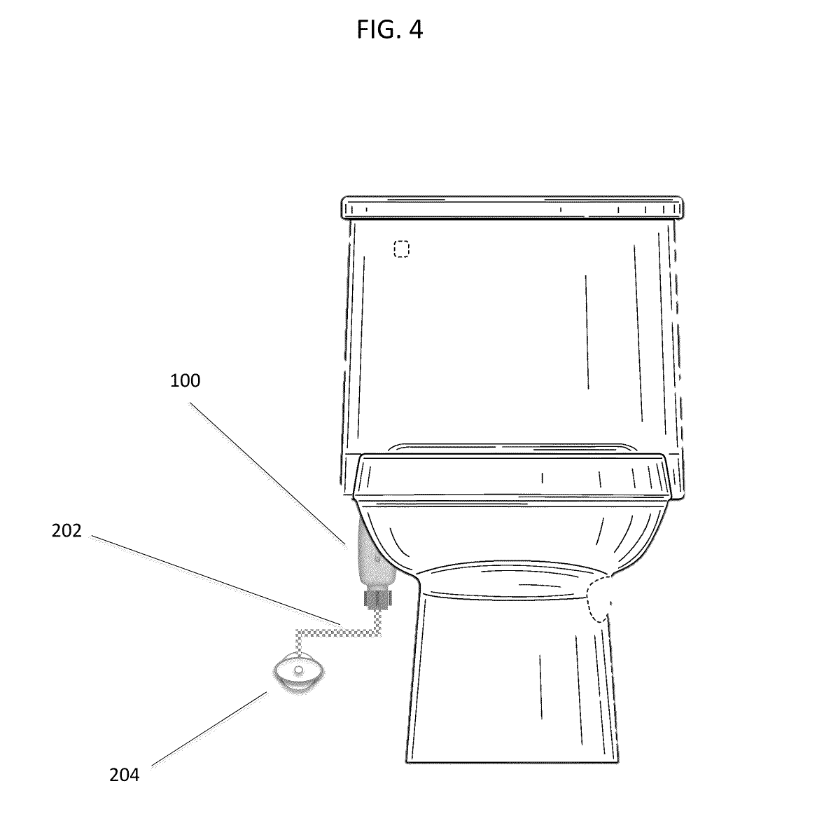

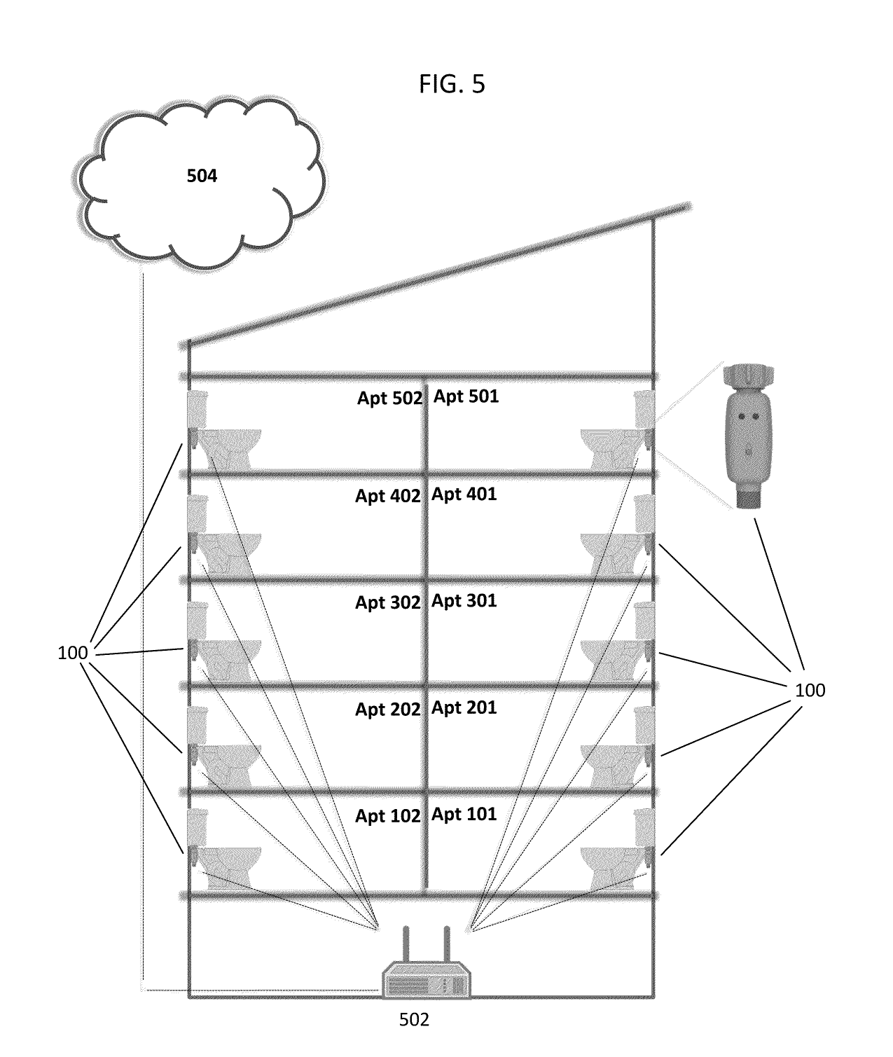

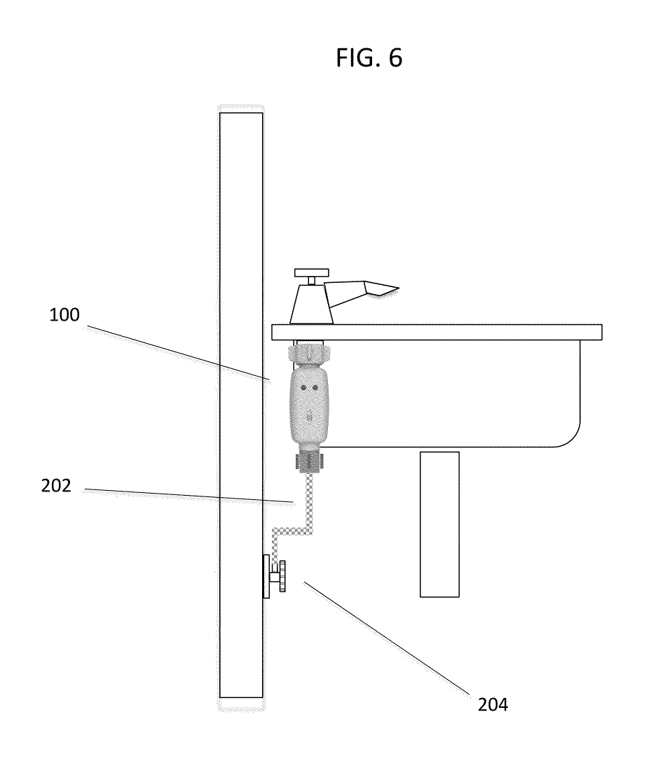

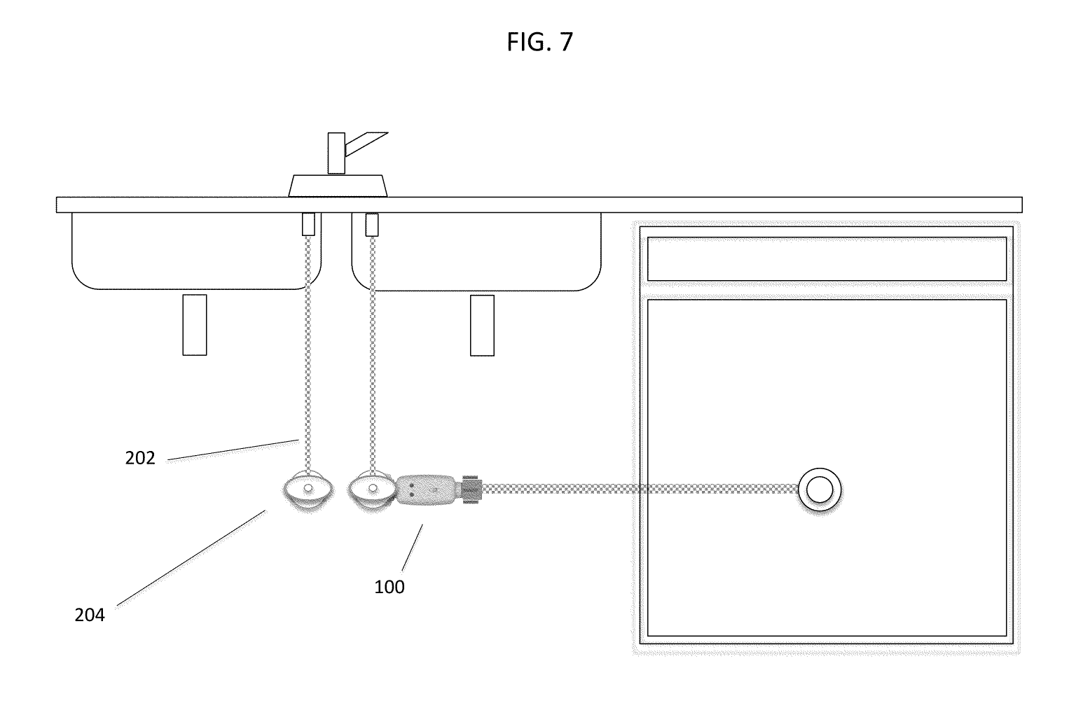

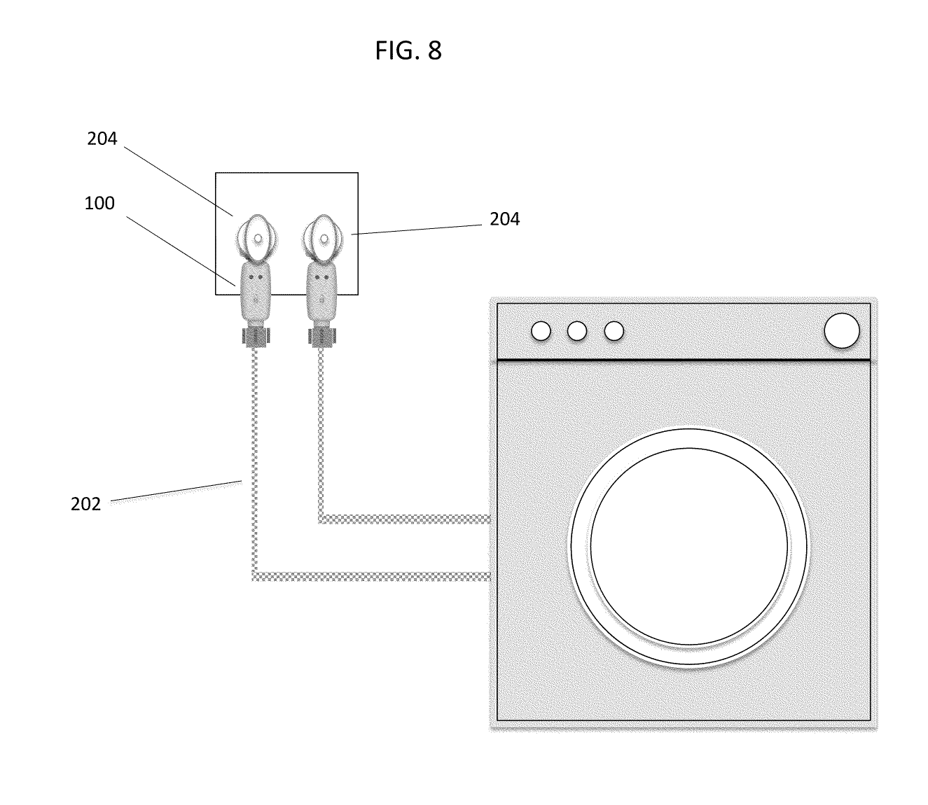

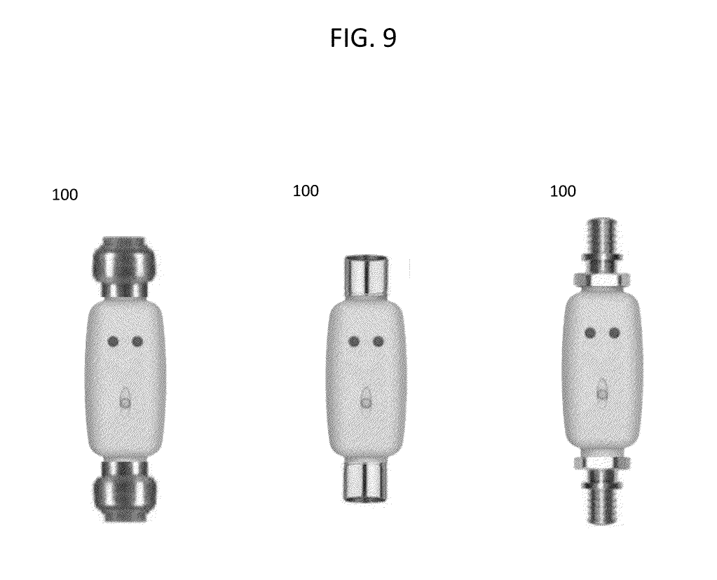

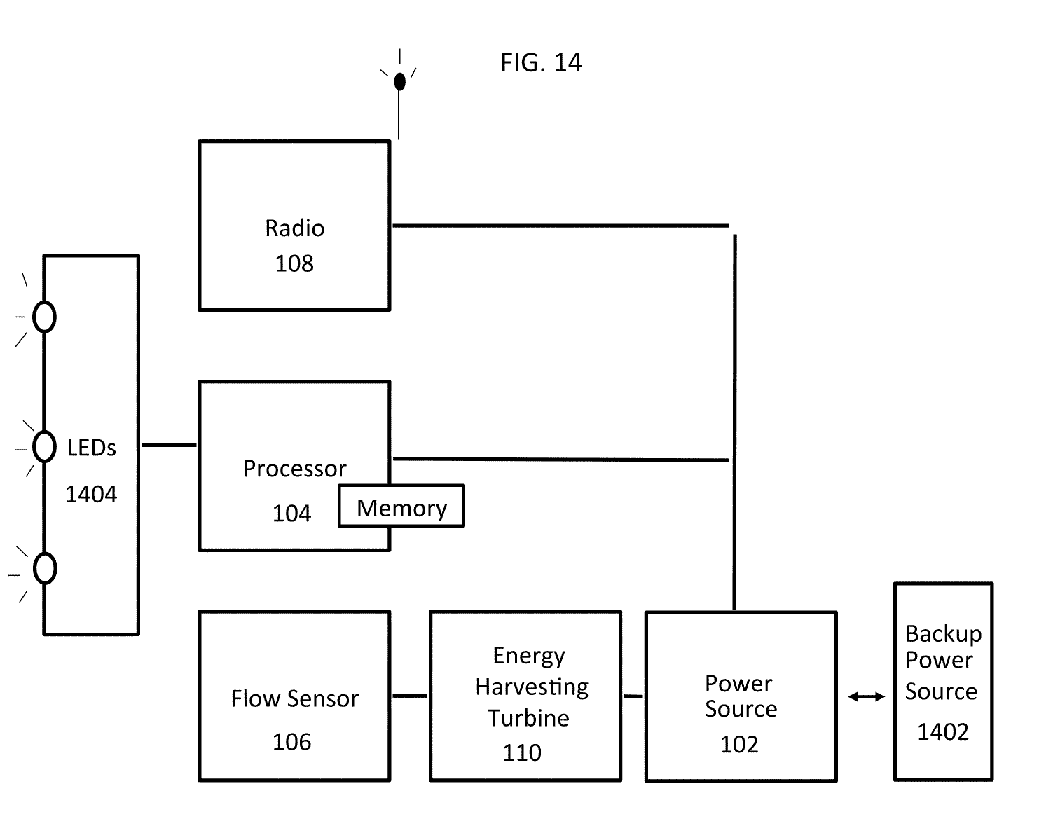

The disclosed system is a dynamic, distributed-sensor, fluid-monitoring system that can include, but is not limited to, a power source 102 such as a battery, rechargeable battery, or capacitor, and further includes a processor 104, such as a microprocessor, with memory, a flow sensor 106, a radio 108, an energy-harvesting turbine 110, a wireless router or gateway 502, and a software component. In some embodiments, the disclosed system may further include a backup power source 1402 and LEDs 1404. An example schematic of the system is illustrated in FIG. 14. A device 100 can house the power source 102, the processor 104, the flow sensor 106, the radio 108, and the energy-harvesting turbine 110, and has at least two connection ends, as illustrated in FIGS. 1 and 9. One of the connection ends of the device 100 attaches to the water supply line 202 of a toilet, as illustrated in FIGS. 2 and 4, or to any other device that uses supply lines, such as, but not limited to, sinks or faucets, as illustrated in FIG. 6, bathtubs, showers, dishwashers, as illustrated in FIG. 7 where the device connects to the rear of the dishwasher, washing machines, as illustrated in FIG. 8, garden hoses, hot water heaters, and HVAC systems. The other connection end of the device 100 can attach to, for example, the toilet tank, as illustrated in FIGS. 2, 3, and 4. The device 100 can also wirelessly connect to the Internet. In one embodiment, as illustrated in FIG. 5, a network of devices 100 exist, wherein each fluid system, such as a toilet, has at least one device 100 attached to it, and the disclosed system can detect and coordinate flow detection between all devices 100.

The disclosed system detects fluid flow, using the flow sensor 106, and communicates, using the radio 108, the flow coming from the water supply line 202 into the tank or other device traditionally connected to pipes. The flow sensor 106 can measure the flow of the fluid, and the radio 108 can relay the flow information using any variety of custom or standard wireless protocols to a wireless router or gateway 502. Examples of wireless protocols include, but are not limited to, LoRa, Wi-Fi, ZigBee, and 6LoWPAN. The wireless router or gateway 502 can be, but are not limited to, LoRa, GSM, EDGE, HSPA/HSPA+, CDMA-1XRTT, or EV-DO. The wireless router or gateway 502 can, after receiving the flow information, relay the flow information to a central server in, for example, a cloud-based computing environment 504, wherein a measurement database stores a plurality of measurements. Said measurements can then be associated with specific users. Each user can configure events that trigger alerts based on flow volume and/or flow duration criteria that may constitute a leak. When actual measurements meet or exceed the flow volume and/or flow duration criteria set by a user, the user can automatically be sent an alert via, for example, SMS, electronic mail, or application notifications (i.e., smartphone applications).

The device 100 allows for easy installation in a toilet because it uses threads for a standard toilet fixture on the connection ends, such as, but not limited to, ⅞″ Female NPT 112 and ⅞″ Male NPT 114. To install, a user can connect the ⅞″ Male NPT 112 to the water supply line 202, which is connected to a shut-off valve 204 at a wall, and can connect the ⅞″ Female NPT 114 to the toilet tank inlet, as illustrated in FIGS. 2-4. Therefore, in one embodiment, when water is flowing to the toilet tank, it will flow from the ⅞″ Male NPT 112 end of the device 100, past the energy-harvesting turbine 110, past the flow sensor 106, past the processor 104 and radio 108, and past the power source 102 to the ⅞″ Female NPT 114 end of the device and into the tank.

In another embodiment, the device can have ends with standard plumbing fittings of other sizes, such as, but not limited to, ½″, ¾″, 1″, which allow it to be placed in-line using common materials, such as, but not limited to, copper fittings, PEX fittings, and the SharkBite® Connection System. Embodiments with various plumbing fittings and connection capabilities are illustrated in FIG. 9.

In another embodiment, water can flow the opposite direction through the device 100. For example, with a garden hose, the ⅞″ Female NPT 114 can connect to the water supply line 202, which is connected to a shut-off valve 204 at a wall, and the ⅞″ Male NPT 112 can attach to the garden hose, so that the water flows from the pipe and into the ⅞″ Female NPT 114 end of the device 100, past the other components of the device 100, to the ⅞″ Male NPT 112 end of the device 100, and into the hose.

In an alternative embodiment, the device 100 can have modular end connection pieces, wherein both ends can be ⅞″ Male NPT 112, both ends can be ⅞″ Female NPT 114, or one end can be ⅞″ Male NPT 112 and one end can be ⅞″ Female NPT 114. This structure enables a user to use the device 100 on any type of pipe regardless of the connection type and the fluid flow direction.

The device 100 can also be self-powered via an energy-harnessing turbine 110 that recharges the power source 102, such as a battery, rechargeable battery, or capacitor. For example, the energy-harnessing turbine 110 may utilize the energy generated by water flow as it moves through the energy-harnessing turbine 110 by storing the generated energy in the power source. Therefore, in a preferred embodiment, the device 100 does not require an external power supply.

In some embodiments, the device 100 can be attached to several toilets in independent units of a building, as illustrated in FIG. 5. For example, an apartment owner can attach one device 100 per toilet to each unit's toilet or toilets and can virtually monitor the water flow for each toilet by viewing the water flow measurements in a cloud-based computing environment 504, wherein the measurements are sent from the device 100 through a wireless router or gateway 502 to the cloud-based computing environment 504.

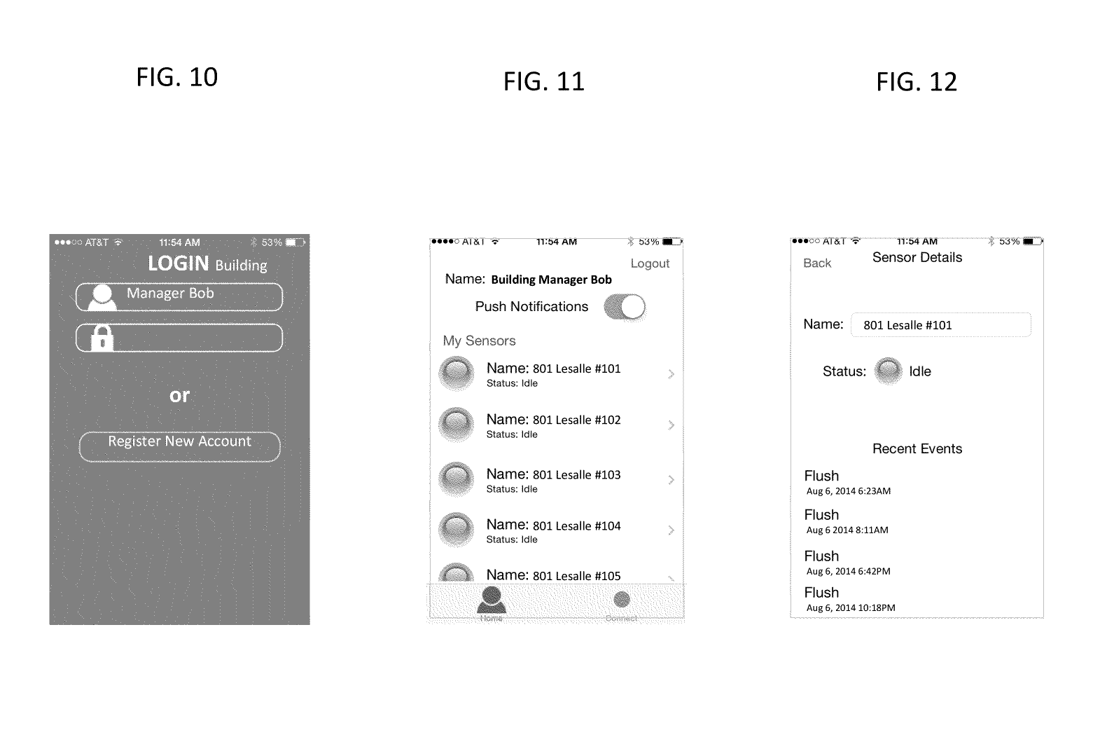

The software component, embodiments of which are illustrated in FIGS. 10-12, permits a user to monitor one or more toilets at once. For example, a user can register and login to an account, as illustrated in FIG. 10. The account can permit the user to create a profile and it can have different “permission levels,” enabling various users to see at least some of the data. Once a user logs in, the user can view the status of all devices 100 on a dashboard, as illustrated in FIG. 11. From this dashboard, a user can select a specific sensor to view more details about the sensor's status. The details can include information such as, but not limited to, the name of the sensor, the location of the sensor, the sensor's status, and recent events, as illustrated in FIG. 12.

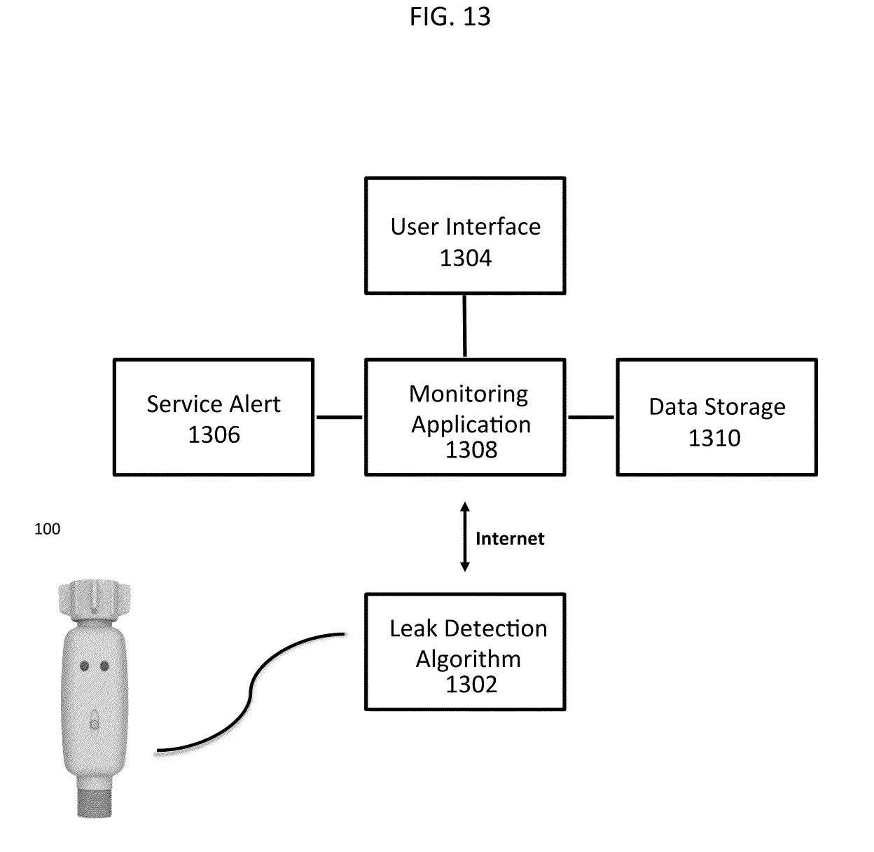

FIG. 13 illustrates one embodiment of the software architecture, wherein the leak detection algorithm 1302, implemented in the device 100, can determine if there is a leak and the device 100 can then communicate with the software component. The software component can include a user interface 1304, data storage 1310, and means for producing a service alert 1306. In some embodiments, the software component is a monitoring application 1308 that connects to the device 100 to obtain information from the leak detection algorithm 1302.

While the disclosed system can, in some embodiments, be used for water-based outlets such as toilets, bathtubs, showers, sinks, dishwashers, garden hoses, hot water heaters, and HVAC systems, it can also be used to detect leaks in other closed-liquid system for liquids such as, but not limited to, oil and gasoline.

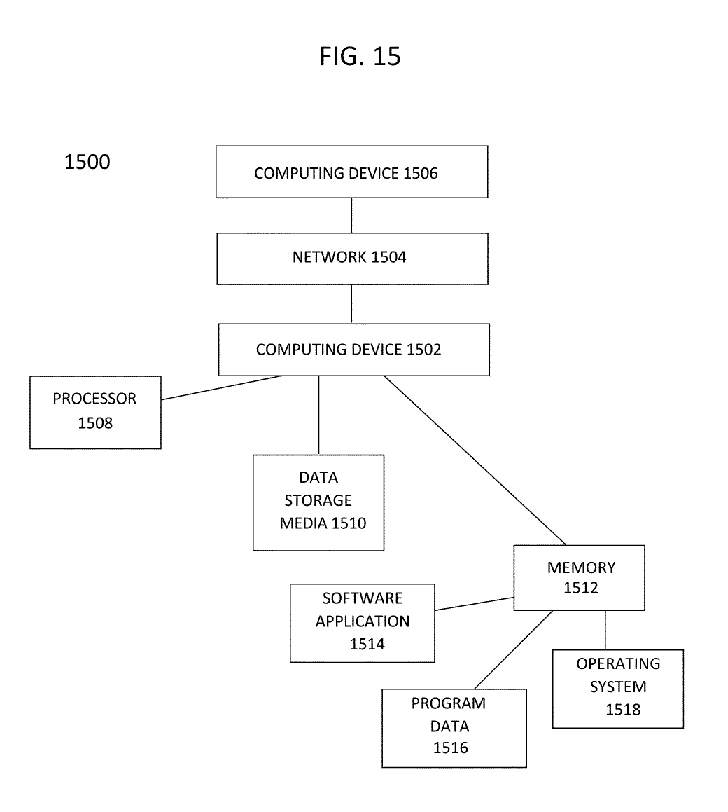

In some embodiments, the system described herein uses a computing system to carry out the various functions described herein. FIG. 15 is a schematic block diagram of an example computing system 1500. The example computing system 1500 includes at least one computing device 1502. In some embodiments the computing system 1500 further includes a communication network 1504 and one or more additional computing devices 1506 (such as a server).

The computing device 1502 can be, for example, located in a user's home or other place of business. In some embodiments, computing device 1502 is a mobile device. The computing device 1502 can be a stand-alone computing device or a networked computing device that communicates with one or more other computing devices 1506 across a network 1504. The additional computing device(s) 1506 can be, for example, located remotely from the first computing device 1502, but configured for data communication with the first computing device 1502 across a network 1504.

In some examples, the computing devices 1502 and 1506 include at least one processor or processing unit 1508 and system memory 1512. The processor 1508 is a device configured to process a set of instructions. In some embodiments, system memory 1512 may be a component of processor 1508; in other embodiments system memory 1512 is separate from the processor 1508. Depending on the exact configuration and type of computing device, the system memory 1512 may be volatile (such as RAM), non-volatile (such as ROM, flash memory, etc.) or some combination of the two. System memory 1512 typically includes an operating system 1518 suitable for controlling the operation of the computing device 1502, such as the WINDOWS® operating systems or the OS X operating system, or a server, such as Windows SharePoint Server, also from Microsoft Corporation, or such as a Mac Mini with OS X. The system memory 1512 may also include one or more software applications 1514 and may include program data 1516.

The computing device 1502 may have additional features or functionality. For example, the computing device 1502 may also include additional data storage devices 1510 (removable and/or non-removable) such as, for example, magnetic disks, optical disks, or tape. Computer storage media 1510 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media 1510 includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 1502. An example of computer storage media 1510 is non-transitory media.

In some examples, one or more of the computing devices 1502 and 1506 can be located in an establishment. In other examples, the computing device 1502 can be a personal computing device that is networked to allow the user to access and utilize the system disclosed herein from a remote location, such as in a user's home, office or other location. In some embodiments, the computing device 1502 is a smart phone tablet, laptop computer, personal digital assistant, or other mobile device. In some embodiments, system operations and functions are stored as data instructions for a smart phone application. A network 1504 facilitates communication between the computing device 1502 and one or more servers, such as an additional computing device 1506, that hosts the system. The network 1504 may be a wide variety of different types of electronic communication networks. For example, the network 1504 may be a wide-area network, such as the Internet, a local-area network, a metropolitan-area network, or another type of electronic communication network. The network 1504 may include wired and/or wireless data links. A variety of communications protocols may be used in the network 1504 including, but not limited to, LoRa, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1506 is a Web server. In this example, the first computing device 1502 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor 1508 of the one or more computing devices 1502 or 1506, the instructions cause the processor 1508 to perform one or more of the operations or methods disclosed herein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A fluid-monitoring system comprising:
a device with a first end and a second end that houses:
a power source;
a microprocessor;
a flow sensor;
a radio;
an energy-harvesting turbine;
a wireless router; and
software stored in a central server;
wherein:
the device attaches on the first end to a fluid supply line and on the second end to a fluid outlet;
the flow sensor measures the flow of a fluid flowing through the device;
the radio communicates the flow measurement to the wireless router; and
the wireless router relays the flow measurement to the central server.

2. The system of claim 1, wherein the fluid outlet is a toilet.

3. The system of claim 1, wherein the power source is a rechargeable battery.

4. The system of claim 1, wherein the power source is a capacitor.
